(19) United States
(12) Patent Application Publication
(10) Pub. No.: US 2018/0174533 A1
(43) Pub. Date: Jun. 21, 2018

(54) Driving Circuit Based on Liquid Crystal Panel and Liquid Crystal Panel

(71) Applicant: Wuhan China Star Optoelectronics Technology Co., Ltd, Wuan, Hubei (CN)

(72) Inventor: Taisheng AN, Shenzhen, Guangdong (CN)

(73) Assignee: Wuhan China Star Optoelectronics Technology Co., Ltd., Wuhan, Hubei (CN)

(21) Appl. No.: 15/118,871

(22) PCT Filed: Jul. 21, 2016
(86) PCT No.: PCT/CN2016/090885

§ 371 Date: Aug. 13, 2016

(30) Foreign Application Priority Data
Jul. 1, 2016 (CN) 201610514640.3

(51) Int. Cl. G09G 3/36

(52) U.S. Cl. CPC G09G 3/3607; G09G 3/3688; G09G 2310/0297; G09G 2310/08; G09G 2300/0426; G09G 2300/0809; G09G 2300/0452

(57) ABSTRACT

The present disclosure discloses a driving circuit based on liquid crystal panel and a liquid crystal panel. The liquid crystal panel comprises a four-color pixel array arranged in a matrix. Each pixel in the four-color pixel array comprises two sub-pixels with different colors. Wherein, the driving circuit comprises a source driving circuit chip and multiple multiplexing circuits. The source driving circuit chip is used to provide multiple source driving signals. Each said multiplexing circuit is used to receive the source driving signal and transmits the source driving signal to multiple sub-pixel columns corresponding to the source driving signal in the four-color pixel array at different times. Through the above way, the present disclosure can greatly reduce the amount of the source driving signals, which greatly decreases the size of the source driving chip, and thus saves the costs of the source driving chip.

### BACKGROUND OF THE INVENTION

### 1. Field of the Invention

The present disclosure relates to the fields of liquid crystal display technology, and in particular to a driving circuit based on liquid crystal panel and a liquid crystal panel.

### 2. The Related Arts

Conventional liquid crystal panel used for mobile terminal generally utilizes RGB pixel arrangement. Wherein, one pixel comprises three sub-pixels, i.e., one pixel comprises R sub-pixel, G sub-pixel, and B sub-pixel. In order to achieve the resolution of N×M of the liquid crystal panel, each column of sub-pixels require one source driving signal. At this time, the source driving chip needs to provide 3N source driving signals. It can be understood that 3N source driving signals require the source driving chip to provide 3N source driving signal lines to transmit, so that the size of the source driving chip will be too large, and thus the costs of the source driving chip will be greatly increased.

### SUMMARY OF THE INVENTION

The technical issue to be solved by the present disclosure is to provide a driving circuit and a liquid crystal panel, which can greatly decrease the size of the source driving chip, and thus saves the costs of the source driving chip.

To solve the above technical problem, one aspect of the present disclosure is to provide a driving circuit based on liquid crystal panel, the liquid crystal panel comprising a four-color pixel array arranged in a matrix, each pixel in the four-color pixel array comprising two sub-pixels with different colors; wherein, the driving circuit comprises a source driving circuit chip and multiple multiplexing circuits, the source driving circuit chip is used to provide multiple source driving signals, each said multiplexing circuit is used to receive the source driving signal and transmits the source driving signal to multiple sub-pixel columns corresponding to the source driving signal in the four-color pixel array at different times; wherein, the source driving circuit chip comprises multiple first output terminal, the multiplexing circuit comprises an input terminal, multiple control terminals, and multiple second output terminals, the first output terminal of the source driving circuit chip is connected with the input terminal of the multiplexing circuit, the multiple control terminals of the multiplexing circuit respectively receive multiple control signals, the multiple second output terminals of the multiplexing circuit are respectively connected with multiple sub-pixel columns in the four-color pixel array; wherein, the four-color pixel array comprises multiple sub-pixel rows arranged in column direction, each sub-pixel row comprises multiple sub-pixels with different colors periodically arranged in row direction.

Wherein, the multiplexing circuit comprises an input terminal, three control terminals, and three second output terminals, the multiplexing circuit further comprises three transistors; wherein, the input terminal is respectively connected with the drains of the three transistors, the gates of the three transistors are respectively connected with the three control terminals, the sources of the three transistors are respectively connected with the three second output terminals.

To solve the above technical problem, another aspect of the present disclosure is to provide a driving circuit based on liquid crystal panel, the liquid crystal panel comprising a four-color pixel array arranged in a matrix, each pixel in the four-color pixel array comprising two sub-pixels with different colors; wherein, the driving circuit comprises a source driving circuit chip and multiple multiplexing circuits, the source driving circuit chip is used to provide multiple source driving signals, each said multiplexing circuit is used to receive the source driving signal and transmits the source driving signal to multiple sub-pixel columns corresponding to the source driving signal in the four-color pixel array at different times.

Wherein, the source driving circuit chip comprises multiple first output terminal, the multiplexing circuit comprises an input terminal, multiple control terminals, and multiple second output terminals, the first output terminal of the source driving circuit chip is connected with the input terminal of the multiplexing circuit, the multiple control terminals of the multiplexing circuit respectively receive multiple control signals, the multiple second output terminals of the multiplexing circuit are respectively connected with multiple sub-pixel columns in the four-color pixel array.

Wherein, the multiplexing circuit comprises an input terminal, three control terminals, and three second output terminals, the multiplexing circuit further comprises three transistors; wherein, the input terminal is respectively connected with the drains of the three transistors, the gates of the three transistors are respectively connected with the three control terminals, the sources of the three transistors are respectively connected with the three second output terminals.

Wherein, the multiplexing circuit comprises an input terminal, six control terminals, and six second output terminals, the multiplexing circuit further comprises six transistors; wherein, the input terminal is respectively connected with the drains of the six transistors, the gates of the three transistors are respectively connected with the six control terminals, the sources of the six transistors are respectively connected with the six second output terminals.

Wherein, the four-color pixel array comprises multiple sub-pixel rows arranged in column direction, each sub-pixel row comprises multiple sub-pixels with different colors periodically arranged in row direction.

Wherein, each sub-pixel row comprises multiple sub-pixels of red sub-pixel, green sub-pixel, blue sub-pixel, and white sub-pixels periodically arranged in row direction.

Wherein, the two sub-pixels forming one pixel are red sub-pixel and green sub-pixel or blue sub-pixel and white sub-pixel.

Wherein, the four-color pixel array comprises multiple sub-pixel rows arranged in column direction, every two rows of sub-pixel rows are repeatedly arranged, odd rows of sub-pixel rows comprises multiple sub-pixels periodically arranged in a first order in row direction, even rows of sub-pixel rows comprises multiple sub-pixels periodically arranged in a second order in row direction.

Wherein, the four-color pixel array comprises multiple sub-pixel rows arranged in column direction, every four rows of sub-pixel rows are repeatedly arranged, the first row of sub-pixel row, the second row of sub-pixel row, the third row of sub-pixel row, and the fourth row of sub-pixel row in every four rows of sub-pixel rows periodically arranged respectively in a first order, a second order, a third order, and a fourth order in row direction.

To solve the above technical problem, another aspect of the present disclosure is to provide a liquid crystal panel, comprising a four-color pixel array arranged in a matrix, each pixel in the four-color pixel array comprising two sub-pixels with different colors; wherein, the liquid crystal panel comprises a driving circuit, the driving circuit comprises a source driving circuit chip and multiple multiplexing circuits, the source driving circuit chip is used to provide multiple source driving signals, each said multiplexing circuit is used to receive the source driving signal and transmits the source driving signal to multiple sub-pixel columns corresponding to the source driving signal in the four-color pixel array at different times.

Wherein, the source driving circuit chip comprises multiple first output terminal, the multiplexing circuit comprises an input terminal, multiple control terminals, and multiple second output terminals, the first output terminal of the source driving circuit chip is connected with the input terminal of the multiplexing circuit, the multiple control terminals of the multiplexing circuit respectively receive multiple control signals, the multiple second output terminals of the multiplexing circuit are respectively connected with multiple sub-pixel columns in the four-color pixel array.

Wherein, the multiplexing circuit comprises an input terminal, three control terminals, and three second output terminals, the multiplexing circuit further comprises three transistors; wherein, the input terminal is respectively connected with the drains of the three transistors, the gates of the three transistors are respectively connected with the three control terminals, the sources of the three transistors are respectively connected with the three second output terminals.

Wherein, the multiplexing circuit comprises an input terminal, six control terminals, and six second output terminals, the multiplexing circuit further comprises six transistors; wherein, the input terminal is respectively connected with the drains of the six transistors, the gates of the three transistors are respectively connected with the six control terminals, the sources of the six transistors are respectively connected with the six second output terminals.

Wherein, the four-color pixel array comprises multiple sub-pixel rows arranged in column direction, each sub-pixel row comprises multiple sub-pixels with different colors periodically arranged in row direction.

Wherein, each sub-pixel row comprises multiple sub-pixels of red sub-pixel, green sub-pixel, blue sub-pixel, and white sub-pixels periodically arranged in row direction.

Wherein, the two sub-pixels forming one pixel are red sub-pixel and green sub-pixel or blue sub-pixel and white sub-pixel.

Wherein, the four-color pixel array comprises multiple sub-pixel rows arranged in column direction, every two rows of sub-pixel rows are repeatedly arranged, odd rows of sub-pixel rows comprises multiple sub-pixels periodically arranged in a first order in row direction, even rows of sub-pixel rows comprises multiple sub-pixels periodically arranged in a second order in row direction.

Wherein, the four-color pixel array comprises multiple sub-pixel rows arranged in column direction, every four rows of sub-pixel rows are repeatedly arranged, the first row of sub-pixel row, the second row of sub-pixel row, the third row of sub-pixel row, and the fourth row of sub-pixel row in every four rows of sub-pixel rows periodically arranged respectively in a first order, a second order, a third order, and a fourth order in row direction.

The benefits of the present disclosure are as follows. Distinguishing from the existing technology, the driving circuit based on liquid crystal panel and the liquid crystal panel according to the present disclosure utilizes the four-color pixel array, and every two sub-pixels with different colors in the four-color pixel array act as a pixel, so it can greatly reduce the amount of the source driving signals, and thus decrease the size of the source driving chip. Moreover, because of the introduction of the multiplexing circuit, one source driving signal can drive multiple sub-pixels, which can further reduce the source driving signals, and thus decrease the size of the source driving chip.

### BRIEF DESCRIPTION OF THE DRAWINGS

FIG. 1 is a schematic structure of the liquid crystal panel according to the embodiment of the present disclosure;

FIG. 2 is a schematic structure of another embodiment of the multiplexing circuit in the liquid crystal panel as shown in FIG. 1;

FIG. 3 is a schematic structure of further embodiment of the multiplexing circuit in the liquid crystal panel as shown in FIG. 1;

FIG. 4 is a schematic arrangement of another embodiment of the four-color pixel array in the liquid crystal panel as shown in FIG. 1; and

FIG. 5 is a schematic arrangement of further embodiment of the four-color pixel array in the liquid crystal panel as shown in FIG. 1.

### DETAILED DESCRIPTION OF THE PREFERRED EMBODIMENTS

The detailed descriptions accompanying drawings and the embodiment of the present invention are as follows.

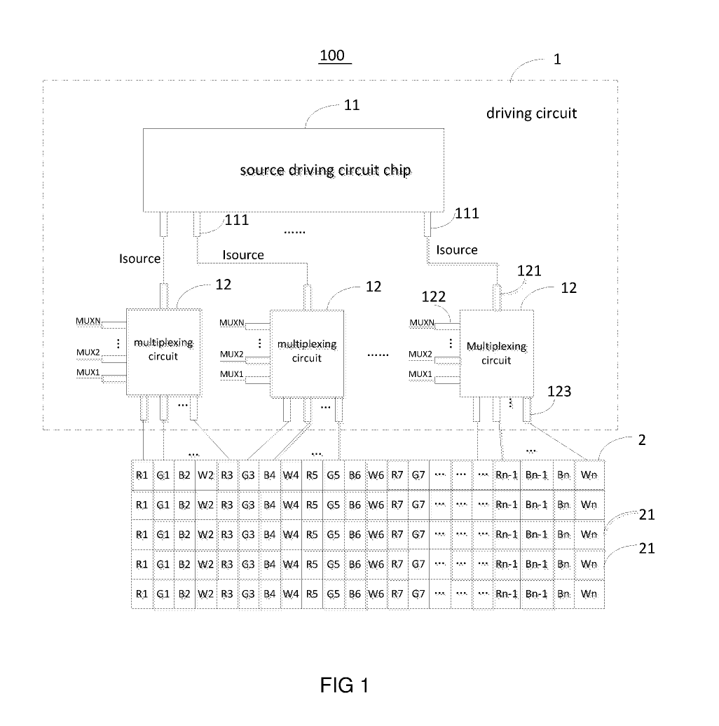

FIG. 1 is a schematic structure of the liquid crystal panel according to the embodiment of the present disclosure. As shown in FIG. 1, the liquid crystal panel 100 comprises a driving circuit 1 and a four-color pixel array 2 arranged in a matrix. Wherein, the driving circuit 1 is used to drive the four-color pixel array 2. Each pixel in the four-color pixel array 2 comprises two sub-pixels with different colors.

Wherein, the driving circuit 1 comprises a source driving circuit chip 11 and multiple multiplexing circuits 12. The source driving circuit chip 11 is used to provide multiple source driving signals Isource. Each said multiplexing circuit 12 is used to receive the source driving signal Isource and respectively transmits the source driving signal Isource to multiple sub-pixel columns corresponding to the source driving signal Isource in the four-color pixel array 2.

Wherein, the source driving circuit chip 11 comprises multiple first output terminal 111. The multiplexing circuit 12 comprises an input terminal 121, multiple control terminals 122, and multiple second output terminals 123. The first output terminal 111 of the source driving circuit chip 11 is connected with the input terminal 121 of the multiplexing circuit 12. The multiple control terminals 122 of the multiplexing circuit 12 respectively receive multiple control signals MUX1, MUX2, . . . MUXN. The multiple second output terminals 123 of the multiplexing circuit 12 are respectively connected with multiple sub-pixel columns in the four-color pixel array 2.

Wherein, the four-color pixel array 2 comprises multiple sub-pixel rows 21 arranged in column direction. Each sub-pixel row 21 comprises multiple sub-pixels with different colors periodically arranged in row direction. In the present embodiment, each sub-pixel row 21 comprises multiple sub-pixels periodically arranged in accordance with the RGBW order, i.e., red sub-pixel, green sub-pixel, blue sub-pixel, white sub-pixel, in row direction. Wherein, two adjacent sub-pixels form one pixel. In the present embodiment, the two sub-pixels forming one pixel are red sub-pixel and green sub-pixel or blue sub-pixel and white sub-pixel. Specifically, in respect to one row of the sub-pixel row 21, the first pixel comprises a first red sub-pixel R1 and a first green sub-pixel G1, the second pixel comprises a second blue sub-pixel B2 and a second white sub-pixel W2, the third pixel comprises a third red sub-pixel R3 and a third green sub-pixel G3, the fourth pixel comprises a fourth blue sub-pixel B4 and a fourth white sub-pixel W4, and so on to the last pixel of the sub-pixel row.

Those skilled in the art will appreciate that, in the other embodiment, each sub-pixel row in the four-color pixel array can also be arranged in different orders of GBWR, BWRG, etc. The present disclosure is not limited to it.

In the present embodiment, compared with the prior art, in respect to the resolution of N×M, in the RGB display screen according to the prior art, each pixel point comprises three sub-pixels of red sub-pixel, green sub-pixel, and blue sub-pixel. At this time, the source driving chip needs to provide 3N source driving signals. However, in the RGBW display screen according to the present disclosure, each pixel point comprises two sub-pixels. At this time, the source driving chip only needs to provide 2N source driving signals. Moreover, because of the introduction of the multiplexing circuit, one source driving signal can drive multiple sub-pixels, such as m pixels. Therefore, the source driving chip only needs to provide 2N/m source driving signals, which can greatly decrease the size of the source driving chip, and thus saves the costs of the source driving chip.

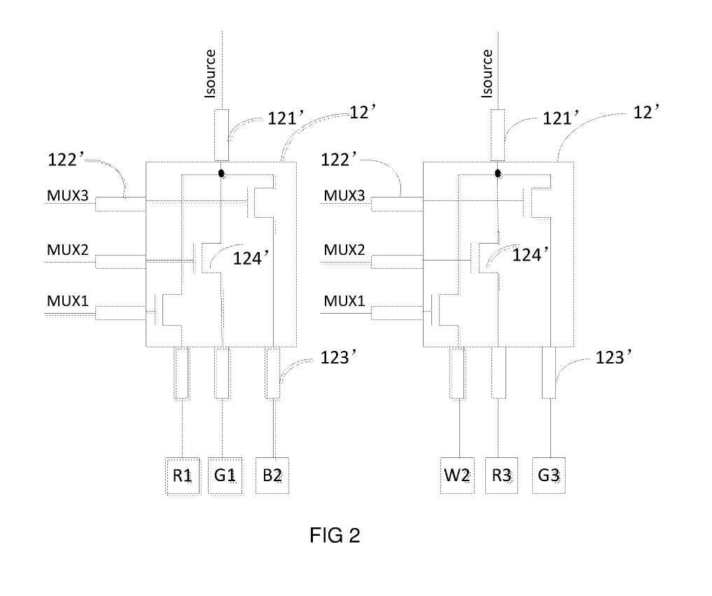

Please also refer to FIG. 2, FIG. 2 is a schematic structure of another embodiment of the multiplexing circuit in the liquid crystal panel as shown in FIG. 1. As shown in FIG. 2, the multiplexing circuit 12′ comprises an input terminal 121′, three control terminals 122′, and three second output terminals 123′. In addition, the multiplexing circuit 12′ further comprises three transistors 124′.

Wherein, after the input terminal 121′ is connected with the first output terminal 111 of the source driving circuit chip 11 and receives the source driving signal Isource, the input terminal 121′ is respectively connected with the drains of the three transistors 124′, the gates of the three transistors 124′ are respectively connected with the three control terminals 122′, which is used to receive the three different control signals MUX1, MUX2, and MUX3, the sources of the three transistors 124′ are respectively connected with the three second output terminals 123′ to control three sub-pixel columns in the four-color pixel array 2.

In the present embodiment, in respect to a sub-pixel row, every multiplexing circuit 12′ controls three sub-pixels. Specifically, the first multiplexing circuit 12′ controls the first red sub-pixel R1 and the first green sub-pixel G1, and the second blue sub-pixel B2, the second multiplexing circuit 12′ controls the second white sub-pixel W2, the third red sub-pixel R3, and the third green sub-pixel G3, and so on. Wherein, the first red sub-pixel R1 and the first green sub-pixel G1 form the first pixel, the second blue sub-pixel B2 and the second white sub-pixel W2 form the second pixel, the third red sub-pixel R3 and the third green sub-pixel form the third pixel, and so on.

In the present embodiment, the control signal MUX1 is used to control the first sub-pixel in the three sub-pixels, and the control signal MUX3 is used to control the third sub-pixel in the three sub-pixels.

Wherein, the control signals MUX1, MUX2, and MUX3 are effective in time division. The three transistors 124′ connected with the control signals MUX1, MUX2, and MUX3 are turned on corresponding to the time division, so that the source driving signal Isource are transmitted to the first, the second, and the third sub-pixels at different times.

Specifically, in respect to the first multiplexing circuit 12, when the control signal MUX1 is effective, the source driving signal Isource is connected to the first red sub-pixel R1. When the control signal MUX2 is effective, the source driving signal Isource is connected to the first green sub-pixel G1. When the control signal MUX3 is effective, the source driving signal Isource is connected to the second blue sub-pixel B2.

In the present embodiment, compared with the prior art, in respect to the resolution of N×M, each pixel point in the four-color pixel array 2 according to the present disclosure comprises two sub-pixels. The two sub-pixels are red sub-pixel and green sub-pixel or blue sub-pixel and white sub-pixel. Wherein, the multiplexing circuit 12′ is a circuit with one input and three outputs, i.e. the multiplexing circuit 12′ can achieve one source driving signal Isource driving three sub-pixels. Therefore, the source driving circuit chip 11 only needs to provide 2N/3 source driving signals Isource, which can greatly decrease the size of the source driving chip 11, and thus saves the costs of the source driving chip 11.

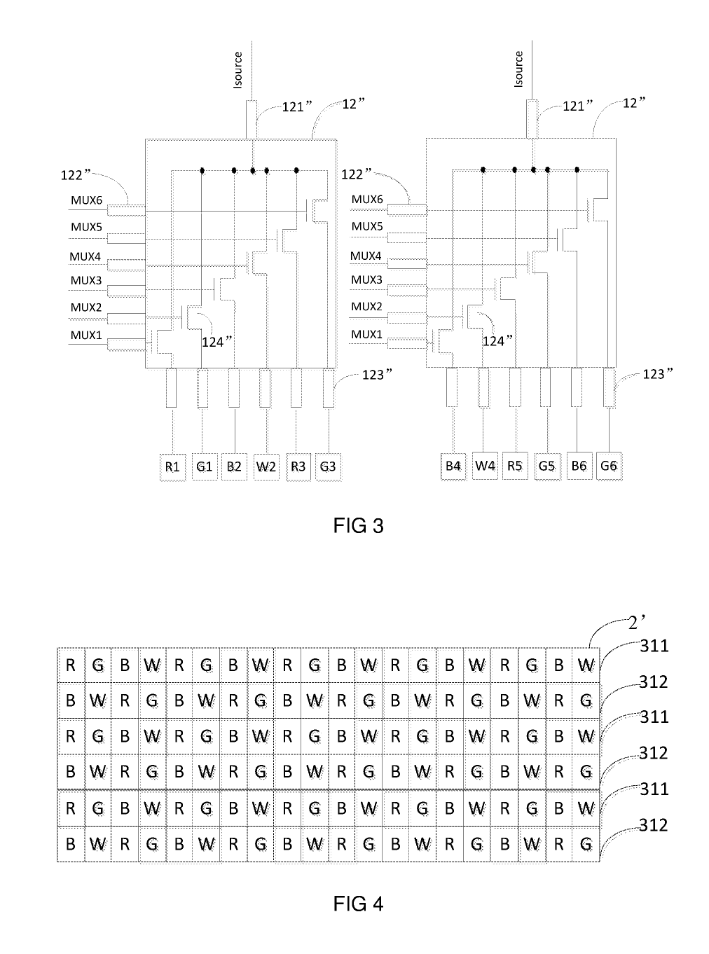

Please also refer to FIG. 3, FIG. 3 is a schematic structure of further embodiment of the multiplexing circuit in the liquid crystal panel as shown in FIG. 1. As shown in FIG. 3, the multiplexing circuit 12″ comprises an input terminal 121″, six control terminals 122″, and six second output terminals 123″. In addition, the multiplexing circuit 12″ further comprises six transistors 124″.

Wherein, after the input terminal 121″ is connected with the first output terminal 111 of the source driving circuit chip 11 and receives the source driving signal Isource, the input terminal 121″ is respectively connected with the drains of the six transistors 124″, the gates of the six transistors 124″ are respectively connected with the six control terminals 122″, which is used to receive the six different control signals MUX1, MUX2, MUX3, MUX4, MUX5, and MUX6, the sources of the six transistors 124″ are respectively connected with the six second output terminals 123″ to control six sub-pixel columns in the four-color pixel array 2.

In the present embodiment, in respect to a sub-pixel row, every multiplexing circuit 12″ controls six sub-pixels. Specifically, the first multiplexing circuit 12″ controls the first red sub-pixel R1 and the first green sub-pixel G1, the second blue sub-pixel B2, the second white sub-pixel W2, the third red sub-pixel R3, and the third green sub-pixel G3. The second multiplexing circuit 12″ controls the fourth blue sub-pixel B4, the fourth white sub-pixel W4, the fifth red sub-pixel R5, the fifth green sub-pixel G5, and the sixth blue sub-pixel B6, and so on. Wherein, the first red sub-pixel R1 and the first green sub-pixel G1 form the first pixel, the second blue sub-pixel B2 and the second white sub-pixel W2 form the second pixel, the third red sub-pixel R3 and the third green sub-pixel G3 form the third pixel, the fourth blue sub-pixel B4 and the fourth white sub-pixel W4 form the fourth pixel, the fifth red sub-pixel R5 and the fifth green sub-pixel G5 form the fifth pixel, the sixth blue sub-pixel B6 and the sixth white sub-pixel W6 form the sixth pixel, and so on.

In the present embodiment, the control signal MUX1 is used to control the first sub-pixel in the six sub-pixels, the control signal MUX2 is used to control the second sub-pixel in the six sub-pixels, the control signal MUX3 is used to control the third sub-pixel in the six sub-pixels, the control signal MUX4 is used to control the fourth sub-pixel in the six sub-pixels, the control signal MUX5 is used to control the fifth sub-pixel in the six sub-pixels, and the control signal MUX6 is used to control the sixth sub-pixel in the six sub-pixels.

Wherein, the control signals MUX1, MUX2, MUX3, MUX4, MUX5, and MUX6 are effective in time division. The six transistors 124′ connected with the control signals MUX1, MUX2, MUX3, MUX4, MUX5, and MUX6 are turned on corresponding to the time division, so that the source driving signal Isource are transmitted to the first, the second, the third, the fourth, the fifth, and the sixth sub-pixels at different times.

Specifically, in respect to the first multiplexing circuit 12″, when the control signal MUX1 is effective, the source driving signal Isource is connected to the first red sub-pixel R1. When the control signal MUX2 is effective, the source driving signal Isource is connected to the first green sub-pixel G1. When the control signal MUX3 is effective, the source driving signal Isource is connected to the second blue sub-pixel B2. When the control signal MUX4 is effective, the source driving signal Isource is connected to the second white sub-pixel W2. When the control signal MUX5 is effective, the source driving signal Isource is connected to the third blue sub-pixel R3. When the control signal MUX6 is effective, the source driving signal Isource is connected to the third green sub-pixel G3.

In the present embodiment, compared with the prior art, in respect to the resolution of N×M, each pixel point in the four-color pixel array 2 according to the present disclosure comprises two sub-pixels. The two sub-pixels are red sub-pixel and green sub-pixel or blue sub-pixel and white sub-pixel. Wherein, the multiplexing circuit 12″ is a circuit with one input and six outputs, i.e. the multiplexing circuit 12″ can achieve one source driving signal Isource driving six sub-pixels. Therefore, the source driving circuit chip 11 only needs to provide 2N/6 source driving signals Isource, which can greatly decrease the size of the source driving chip 11, and thus saves the costs of the source driving chip 11.

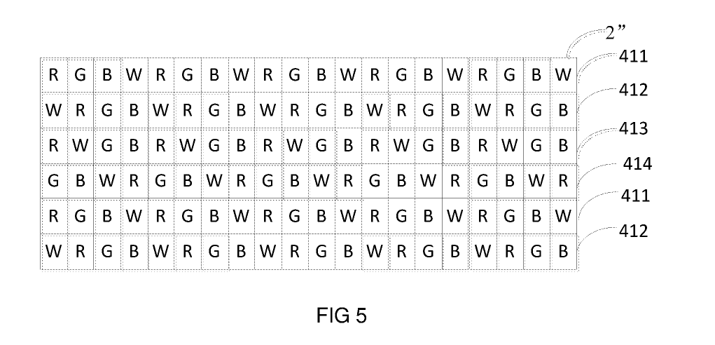

FIG. 4 is a schematic arrangement of another embodiment of the four-color pixel array in the liquid crystal panel as shown in FIG. 1. As shown in FIG. 4, the four-color pixel array 2′ comprises multiple sub-pixel rows arranged in column direction. Wherein, every two rows of sub-pixel rows are repeatedly arranged, which are respectively recorded as odd rows of sub-pixel rows 311 and even rows of sub-pixel lines 312. Odd rows of sub-pixel rows 311 comprises multiple sub-pixels periodically arranged in a first order in row direction, even rows of sub-pixel rows 312 comprises multiple sub-pixels periodically arranged in a second order in row direction. In the present embodiment, the odd rows of sub-pixel rows 311 comprises multiple sub-pixels periodically arranged in accordance with the RGBW order in row direction, the even rows of sub-pixel rows 312 comprises multiple sub-pixels periodically arranged in accordance with the BWRG order in row direction.

Wherein, the two sub-pixels forming one pixel are red sub-pixel and green sub-pixel or blue sub-pixel and white sub-pixel.

Those skilled in the art will appreciate that, in the other embodiment, the odd rows of sub-pixel rows 311 and the even rows of sub-pixel lines 312 in the four-color pixel array 2 can also be arranged in different orders of GBWR and WRGB, GBRW and RWGB, etc. The present disclosure is not limited to it, just ensure that every two rows of sub-pixel rows arranged repeatedly.

FIG. 5 is a schematic arrangement of further embodiment of the four-color pixel array in the liquid crystal panel as shown in FIG. 1. As shown in FIG. 5, the four-color pixel array 2′ comprises multiple sub-pixel rows arranged in column direction. Every two rows of sub-pixel rows are repeatedly arranged. Wherein, the first row of sub-pixel row, the second row of sub-pixel row, the third row of sub-pixel row, and the fourth row of sub-pixel row respectively comprises multiple sub-pixels periodically arranged in a first order, in a second order, in a third order, and in a fourth order in row direction.

In the present embodiment, the first row of sub-pixel row 411, the second row of sub-pixel row 412, the third row of sub-pixel row 413, and the fourth row of sub-pixel row 414 respectively comprises multiple sub-pixels periodically arranged in RGBW order, in WRGB order, in RWGB order, and in GBWR order in row direction.

Wherein, the two sub-pixels forming one pixel are red sub-pixel and green sub-pixel, or blue sub-pixel and white sub-pixel, or white sub-pixel and red sub-pixel, or green sub-pixel and blue sub-pixel, or red sub-pixel and white sub-pixel.

Those skilled in the art will appreciate that, in the other embodiment, the four sub-pixel rows repeatedly arranged in the four-color pixel array 2″ can also be periodically arranged in other four colors orders in row direction. The present disclosure is not limited to it.

The benefits of the present disclosure are as follows. Distinguishing from the existing technology, the driving circuit based on liquid crystal panel and the liquid crystal panel according to the present disclosure utilizes the four-color pixel array, and every two sub-pixels with different colors in the four-color pixel array act as a pixel, so it can greatly reduce the amount of the source driving signals, and thus decrease the size of the source driving chip. Moreover, because of the introduction of the multiplexing circuit, one source driving signal can drive multiple sub-pixels, which can further reduce the source driving signals, and thus decrease the size of the source driving chip.

Embodiments of the present disclosure have been described, but not intending to impose any unduly constraint to the appended claims. Any modification of equivalent structure or equivalent process made according to the disclosure and drawings of the present disclosure, or any application thereof, directly or indirectly, to other related fields of technique, is considered encompassed in the scope of protection defined by the clams of the present disclosure.

What is claimed is:

1. A driving circuit based on liquid crystal panel, the liquid crystal panel comprising a four-color pixel array arranged in a matrix, each pixel in the four-color pixel array comprising two sub-pixels with different colors;
wherein, the driving circuit comprises a source driving circuit chip and multiple multiplexing circuits, the source driving circuit chip is used to provide multiple source driving signals, each said multiplexing circuit is used to receive the source driving signal and transmits the source driving signal to multiple sub-pixel columns corresponding to the source driving signal in the four-color pixel array at different times;
wherein, the source driving circuit chip comprises multiple first output terminal, the multiplexing circuit comprises an input terminal, multiple control terminals, and multiple second output terminals, the first output terminal of the source driving circuit chip is connected with the input terminal of the multiplexing circuit, the multiple control terminals of the multiplexing circuit respectively receive multiple control signals, the multiple second output terminals of the multiplexing circuit are respectively connected with multiple sub-pixel columns in the four-color pixel array;
wherein, the four-color pixel array comprises multiple sub-pixel rows arranged in column direction, each sub-pixel row comprises multiple sub-pixels with different colors periodically arranged in row direction.

2. The driving circuit as claimed in claim 1, wherein the multiplexing circuit comprises an input terminal, three control terminals, and three second output terminals, the multiplexing circuit further comprises three transistors;
wherein, the input terminal is respectively connected with the drains of the three transistors, the gates of the three transistors are respectively connected with the three control terminals, the sources of the three transistors are respectively connected with the three second output terminals.

3. A driving circuit based on liquid crystal panel, the liquid crystal panel comprising a four-color pixel array arranged in a matrix, each pixel in the four-color pixel array comprising two sub-pixels with different colors;
wherein, the driving circuit comprises a source driving circuit chip and multiple multiplexing circuits, the source driving circuit chip is used to provide multiple source driving signals, each said multiplexing circuit is used to receive the source driving signal and transmits the source driving signal to multiple sub-pixel columns corresponding to the source driving signal in the four-color pixel array at different times.

4. The driving circuit as claimed in claim 3, wherein the source driving circuit chip comprises multiple first output terminal, the multiplexing circuit comprises an input terminal, multiple control terminals, and multiple second output terminals, the first output terminal of the source driving circuit chip is connected with the input terminal of the multiplexing circuit, the multiple control terminals of the multiplexing circuit respectively receive multiple control signals, the multiple second output terminals of the multiplexing circuit are respectively connected with multiple sub-pixel columns in the four-color pixel array.

5. The driving circuit as claimed in claim 4, wherein the multiplexing circuit comprises an input terminal, three control terminals, and three second output terminals, the multiplexing circuit further comprises three transistors;
wherein, the input terminal is respectively connected with the drains of the three transistors, the gates of the three transistors are respectively connected with the three control terminals, the sources of the three transistors are respectively connected with the three second output terminals.

6. The driving circuit as claimed in claim 4, wherein the multiplexing circuit comprises an input terminal, six control terminals, and six second output terminals, the multiplexing circuit further comprises six transistors;
wherein, the input terminal is respectively connected with the drains of the six transistors, the gates of the three transistors are respectively connected with the six control terminals, the sources of the six transistors are respectively connected with the six second output terminals.

7. The driving circuit as claimed in claim 3, wherein the four-color pixel array comprises multiple sub-pixel rows arranged in column direction, each sub-pixel row comprises multiple sub-pixels with different colors periodically arranged in row direction.

8. The driving circuit as claimed in claim 7, wherein each sub-pixel row comprises multiple sub-pixels of red sub-pixel, green sub-pixel, blue sub-pixel, and white sub-pixels periodically arranged in row direction.

9. The driving circuit as claimed in claim 8, wherein the two sub-pixels forming one pixel are red sub-pixel and green sub-pixel or blue sub-pixel and white sub-pixel.

10. The driving circuit as claimed in claim 3, wherein the four-color pixel array comprises multiple sub-pixel rows arranged in column direction, every two rows of sub-pixel rows are repeatedly arranged, odd rows of sub-pixel rows comprises multiple sub-pixels periodically arranged in a first order in row direction, even rows of sub-pixel rows comprises multiple sub-pixels periodically arranged in a second order in row direction.

11. The driving circuit as claimed in claim 3, wherein the four-color pixel array comprises multiple sub-pixel rows arranged in column direction, every four rows of sub-pixel rows are repeatedly arranged, the first row of sub-pixel row, the second row of sub-pixel row, the third row of sub-pixel row, and the fourth row of sub-pixel row in every four rows of sub-pixel rows periodically arranged respectively in a first order, a second order, a third order, and a fourth order in row direction.

12. A liquid crystal panel, comprising a four-color pixel array arranged in a matrix, each pixel in the four-color pixel array comprising two sub-pixels with different colors;
wherein, the liquid crystal panel comprises a driving circuit, the driving circuit comprises a source driving circuit chip and multiple multiplexing circuits, the source driving circuit chip is used to provide multiple source driving signals, each said multiplexing circuit is used to receive the source driving signal and transmits the source driving signal to multiple sub-pixel columns corresponding to the source driving signal in the four-color pixel array at different times.

13. The liquid crystal panel as claimed in claim 12, wherein the source driving circuit chip comprises multiple first output terminal, the multiplexing circuit comprises an input terminal, multiple control terminals, and multiple second output terminals, the first output terminal of the source driving circuit chip is connected with the input terminal of the multiplexing circuit, the multiple control terminals of the multiplexing circuit respectively receive multiple control signals, the multiple second output terminals of the multiplexing circuit are respectively connected with multiple sub-pixel columns in the four-color pixel array.

14. The liquid crystal panel as claimed in claim 13, wherein the multiplexing circuit comprises an input terminal, three control terminals, and three second output terminals, the multiplexing circuit further comprises three transistors;
wherein, the input terminal is respectively connected with the drains of the three transistors, the gates of the three transistors are respectively connected with the three control terminals, the sources of the three transistors are respectively connected with the three second output terminals.

15. The liquid crystal panel as claimed in claim 13, wherein the multiplexing circuit comprises an input terminal, six control terminals, and six second output terminals, the multiplexing circuit further comprises six transistors;
wherein, the input terminal is respectively connected with the drains of the six transistors, the gates of the three transistors are respectively connected with the six control terminals, the sources of the six transistors are respectively connected with the six second output terminals.

16. The liquid crystal panel as claimed in claim 12, wherein the four-color pixel array comprises multiple sub-pixel rows arranged in column direction, each sub-pixel row comprises multiple sub-pixels with different colors periodically arranged in row direction.

17. The liquid crystal panel as claimed in claim 16, wherein each sub-pixel row comprises multiple sub-pixels of red sub-pixel, green sub-pixel, blue sub-pixel, and white sub-pixels periodically arranged in row direction.

18. The liquid crystal panel as claimed in claim 17, wherein the two sub-pixels forming one pixel are red sub-pixel and green sub-pixel or blue sub-pixel and white sub-pixel.

19. The liquid crystal panel as claimed in claim 12, wherein the four-color pixel array comprises multiple sub-pixel rows arranged in column direction, every two rows of sub-pixel rows are repeatedly arranged, odd rows of sub-pixel rows comprises multiple sub-pixels periodically arranged in a first order in row direction, even rows of sub-pixel rows comprises multiple sub-pixels periodically arranged in a second order in row direction.

20. The liquid crystal panel as claimed in claim 12, wherein the four-color pixel array comprises multiple sub-pixel rows arranged in column direction, every four rows of sub-pixel rows are repeatedly arranged, the first row of sub-pixel row, the second row of sub-pixel row, the third row of sub-pixel row, and the fourth row of sub-pixel row in every four rows of sub-pixel rows periodically arranged respectively in a first order, a second order, a third order, and a fourth order in row direction.
